(19) United States
(12) Patent Application Publication
(10) Pub. No.: US 2009/0136829 A1
(43) Pub. Date: May 28, 2009

(54) Method and apparatus for reducing lead sulfate compound used in lead-acid battery

(76) Inventors: Sy-Ruen Huang, Taichung (TW); Yan-Chin Lai, Taichung (TW)

Correspondence Address: Sy-Ruen Huang, P.O. Box 44-2049, Taipei, 10668, TW

(21) Appl. No.: 12/292,567

(22) Filed: Nov. 21, 2008

(30) Foreign Application Priority Data
Nov. 23, 2007 (TW) 096144642

(51) Int. Cl. H01M 6/52

(52) U.S. Cl. 429/49

(57) ABSTRACT

The present invention discloses a simple, low-cost and high-efficiency method and an apparatus for reducing a lead sulfate compound used in a lead-acid battery. The method mainly generates high-frequency multi-band harmonic waves and non-thermal equilibrium ions by passing a high-frequency power source through a dielectric barrier discharge receptor to reduce a lead sulfate compound on an electrode plate inside the battery, so as to maintain normal electrochemical reactions including the oxidation and reduction of the battery. The apparatus mainly uses a porous conducting material for the dielectric barrier discharge receptor, such that the high-frequency multi-band harmonic waves and non-thermal equilibrium ions produced by the high-frequency voltage can maintain the normal electrochemical reactions including the oxidation and reduction of the battery to extend the life of the battery.

### BACKGROUND OF THE INVENTION

(1) Field of the Invention

The present invention relates to a method and an apparatus for reducing a lead sulfate compound used in a lead-acid battery (or sealed rechargeable battery), and more particularly to a method and an apparatus using a dielectric barrier discharge plasma (DBD) method to produce a plurality of plasma and high-frequency multi-band harmonic waves and promote the normal oxidation and reduction of a battery to extend the life of a lead-acid battery.

(2) Description of the Prior Art

In present rechargeable batteries, lithium battery or other cost-effective chargeable battery has been used in mobile communication systems, precision electronic instruments, and common digital cameras or mobile phones. However, a lead-acid battery (or a sealed rechargeable battery) comes with long power durability and a sufficient battery level for the use as an automobile battery, an uninterrupted power system (UPS) or an illumination system, and the lead-acid battery is still the first choice of batteries and ranks top among the list of batteries. For example, the lead-acid battery of a motor vehicle (or called “car battery”) comes with lead (Pb) and lead dioxide (PbO₂) electrodes, and uses sulfuric acid (H₂SO₄) as electrolyte. This apparatus primarily provides a sufficient capacity of battery to users by normal chemical reactions including oxidation and reduction.

In general, a lead-acid battery keeps producing crystal sulfates inside the battery under a normal operation process, since the battery is not always charged/discharged fully but always situated at an operating mode, and these crystal sulfates are covered onto an electrode plate to hinder the normal operation of the electrochemical reaction and affect the output of electric power. As the quantity of crystal sulfates on the electrode plates increases, the capacity of the lead-acid battery will drop continuously until the battery power is exhausted.

When the cathode plate of the lead-acid battery discharges electricity, lead sulfate is produced during the process of using lead oxide and sulfuric acid solution for the electrochemical reaction, wherein the lead sulfate is a substance existed in the form of a crystal. In general, abnormal lead sulfate crystals discharge electricity slowly to form large particulate crystals and result in an excessively large current charge/discharge, and a too-tight lead sulfate crystal. The large particulate lead sulfate crystals are covered onto the cathode plate to block active matters, and thus producing a sulfuration (also known as a “Pseudo-capacity phenomenon”). If the extent of covering a lead-acid battery increases, then the battery will lose its charging and discharging capability gradually. In present lead-acid batteries, over 70% of the cases for shortening the life of the batteries are caused by sulfuration.

In general, the causes of sulfuration of the lead-acid battery include the following three situations: (1) Large particulate lead sulfate crystals are formed easily when the charging voltage is set too high or too low; (2) Large dense particulate crystals of the lead sulfate are formed easily due to excessively large charge and discharge of current; and (3) Large particulate lead sulfate crystals are formed by weak spontaneous discharges easily after the use of the lead-acid battery is stopped, and thus the battery level drops significantly after approximately six months and the lead-acid battery will become useless after a year.

The shortened battery life causes a burden to consumers, and the dumped batteries cause pollutions to our environment, and thus the way of maintaining the performance and extending the life for a lead-acid battery requires improvements and solutions.

To overcome the aforementioned shortcomings, manufacturers adopted pulse or high frequency technologies in the products to repair the lead-acid battery, but the pulse or high frequency methods have the following drawbacks:

(1) High-voltage electronic technologies are used to release high-voltage pulses instantly from a power storage device. Since the current produced by the electronic high-voltage pulse is not large, therefore the maintenance and repair time of the lead-acid battery cannot be reduced, and this method is generally installed in a motor vehicle for its application of maintaining and repairing the lead-acid battery in a long time.

(2) The use of high-voltage pulse will produce electromagnetic interference to the electronic instruments. For a long-time use, the electronic device will be damaged by the electromagnetism, although the battery is repaired. The overall benefit is questionable, and this method has a significant adverse effect on the overall application of the motor vehicle or other equipments

(3) The high frequency method switches the circuits to generate a high frequency and applies a power to the battery. Since the current is limited for switching the circuits, it takes a long maintenance and repair time and gives a low performance. Thus, this method is generally used for motor vehicles to maintain and repair a lead-acid battery in a long time.

(4) The frequency produced by the high-frequency method is constant, and the frequency may not be applicable in the sulfurated lead sulfate. It will consume much power and results in no significant benefit, if high-frequency signals are inputted without controlling the structure of the lead sulfate crystals.

(5) High-frequency oscillations will produce high-frequency harmonic waves which will interfere the electronic instruments, and thus have a significant adverse effect on the overall application of motor vehicles and other equipments.

The ways of overcoming the drawbacks of pulse technologies and high frequency technologies are given below:

1. It is necessary to keep a distance from the electronic equipments to avoid electromagnetic interference when the pulse technology and the high-frequency technology are used.

2. The current with increased high-voltage high-frequency pulse will reduce the maintenance and repair time.

At present, a method of applying a high-frequency high-voltage pulse to an electrode plate to disturb a pulse in a battery charge process is used for maintaining and repairing a lead-acid battery. The action of disturbing the pulse resides on: (1) eliminating the conditions of forming large lead sulfate crystals; (2) cracking the lead sulfate crystals by the energy of the increased pulse voltage applied to the electrode plates, since the large lead sulfate crystals covered onto the cathode plate are substance of a large resistivity, and the large lead sulfate crystals and lead oxide are correlated with the electrode plates during the charge/discharge process; (3) producing a resonance to change the structure of the lead sulfate crystal in water solution from dense to loose and from large to small to obtain energies of the same harmonic frequency for conducting an electrochemical reaction again; and (4) providing a charging function to make up the consumption for the discharged battery power, so as to eliminate the sulfates produced by the discharge when the battery is not in use.

Besides the aforementioned method, the battery liquid does not produce a dielectric barrier discharge, but produce a corona discharge in a larger area in the air for the lead-acid in a battery according to the study provided by the inventor of the present invention. As long as the positions of the air and the liquid in the battery allow a gaseous dielectric barrier discharge to take place, the condition of contacting the discharge plasma with the battery liquid is established. Thus, a high voltage can be passed to the positive and negative high-voltage pulses of the dielectric barrier discharge electrode, and a discharge in contact with the battery liquid surface in the air will be produced between the dielectric barrier discharge electrode and the battery liquid. Under the action of high-power electrons, the high-power electrons in the plasma produced by the discharge are collided non-elastically with the molecules (and/or atoms) of the battery liquid to convert energy into internal energy of molecules at the ground state for a series of processes such as excitation, decomposition, and ionization, so that the battery liquid is situated at an activated state. On one hand, the molecular bond of the air inside the battery is opened up to form elemental atoms or monoatomic molecules; on the other hand, the water molecules in plasma and battery liquid or water molecules in the air inside a battery produce large quantity of active groups such as free oxygen, free radicals and ozone. Since active particles composed of these monoatomic molecules, free oxygen, free radicals and ozone causes a chemical reaction to reduce a complicated lead sulfate compound in the lead-acid battery into sulfuric acid and a lead compound, and the decomposition of water molecules drives the lead sulfate crystals to produce H₂SO₄ more quickly to expedite the entire reduction as shown in the following formulas:

e⁻+O₂(in the air or in a battery)→e+2O₂⁻

e⁻+H₂O(in the air or in a battery)→e+OH⁻+H⁺

SO₂(in a battery)+O→SO₃

SO₃+H₂O(in a battery)→H₂SO₄

HSO₃+OH⁻→H₂SO₄

Therefore, a pulse dielectric barrier discharge plasma method used for producing plasma to decompose water molecules while providing a plurality of high-frequency harmonic waves for the decomposition and reduction of lead sulfate crystals is a quick, effective and feasible method.

### SUMMARY OF THE INVENTION

In view of the shortcomings of the prior art, the inventor of the present invention based on years of experience in the related industry to conduct extensive researches and experiments, and finally invented a method and an apparatus for reducing a lead sulfate compound used in a lead-acid battery, wherein a positive half-cycle pulse high-frequency power source is inputted to an anode of the battery anode for charging the battery, and a dielectric barrier discharge receptor is coupled to a cathode of the battery, for producing and providing higher-frequency multi-band harmonic waves and a plurality of plasma into the battery to decompose water molecules in the battery and lead sulfate crystals accumulated on the electrode plates, so as to achieve the effects of reducing a lead sulfate compound, promoting electrochemical reactions including oxidation and reduction of the battery, and extending the life of the battery.

A method for reducing a lead sulfate compound used in a lead-acid battery in accordance with the present invention comprises:

applying a high-frequency power source to a rectifier diode, for generating pulse high-frequency power source to charge a battery;

applying a high-frequency power source to a dielectric barrier discharge receptor, for producing and providing plasma and high-frequency multi-band power source into a battery to reduce a lead sulfate compound; and

repeating the aforementioned steps to promote a normal electrochemical reaction of the lead-acid battery.

The present invention provides a method for reducing a lead sulfate compound used in a lead-acid battery, wherein the high-frequency multi-band power source generated by the dielectric barrier discharge receptor provides at least one different high-frequency harmonic wave; the high-frequency multi-band power source generated by the dielectric barrier discharge receptor provides a dominant frequency from 6 kHz to 12 kHz; the waveform provided by the high-frequency multi-band power source is high-frequency pulse waveform with a sharp rising edge; the voltage supplied by the high-frequency multi-band power source falls within a range of 300V˜600V; the dielectric barrier discharge receptor is a conductive dielectric receptor having a nonlinear time-varying resistor and a nonlinear time-varying capacitor; the pulse provided by the pulse high-frequency power source is a positive half-cycle pulse; and the plasma is a non-thermal equilibrium plasma.

In an apparatus for reducing a lead sulfate compound used in a lead-acid battery in accordance with the present invention, the apparatus comprises: a high-frequency power source generator, for generating a high-frequency power source; a rectifier diode, coupled between the high-frequency power source generator and the lead-acid battery, for generating a pulse high-frequency power source to charge the battery; and a dielectric barrier discharge receptor, coupled between the high-frequency power source generator and the lead-acid battery, for producing and providing plasma and high-frequency multi-band harmonic waves to the battery to reduce a lead sulfate compound; characterized in that: the dielectric barrier discharge receptor is a porous conductive dielectric receptor.

In an apparatus for reducing a lead sulfate compound used in a lead-acid battery in accordance with the present invention, the porous conductive dielectric receptor can be made of a conducting carbon material or a conducting metal material, and the porous conductive dielectric receptor can be a regular mesh structure or an irregular mesh structure, and the porous conductive dielectric receptor can be a sponge-shaped structure with a plurality of irregular air gaps therein.

In an apparatus for reducing a lead sulfate compound used in a lead-acid battery in accordance with the present invention, the high-frequency power source generator comprises:

an input circuit, for providing a power source, and including an AC power, a bridge rectifier, a filter capacitor and a filter inductor;

a boost circuit, for generating a high-voltage power source, and including a transformer and a thyristor; and

a PWM circuit, for modulating a pulse width.

### BRIEF DESCRIPTION OF THE DRAWINGS

FIG. 1 is a block diagram of an operation flow in accordance with a preferred embodiment of the present invention;

FIG. 2 is a schematic circuit diagram of an apparatus in accordance with a preferred embodiment of the present invention;

FIG. 3 is a schematic view of a receptor in accordance with a preferred embodiment of the present invention;

FIG. 4 is a perspective view of a sponge-shaped receptor in accordance with a preferred embodiment of the present invention;

FIG. 5 is a partial view of the structure as depicted in FIG. 4; and

FIG. 6 is a schematic view of a nonlinear time-varying resistor and a non-linear time-varying capacitor and a high-frequency multiband power source in accordance with a preferred embodiment of the present invention.

### DETAILED DESCRIPTION OF THE PREFERRED EMBODIMENTS

In an example of a car battery in accordance with the present invention, the method of the invention is conducted at a location away from electronic instruments, after the car battery is removed, wherein the battery decomposes water molecules and lead sulfate crystals and reduces a lead sulfate compound to promote a normal electrochemical reaction of the battery and extend the life of the battery.

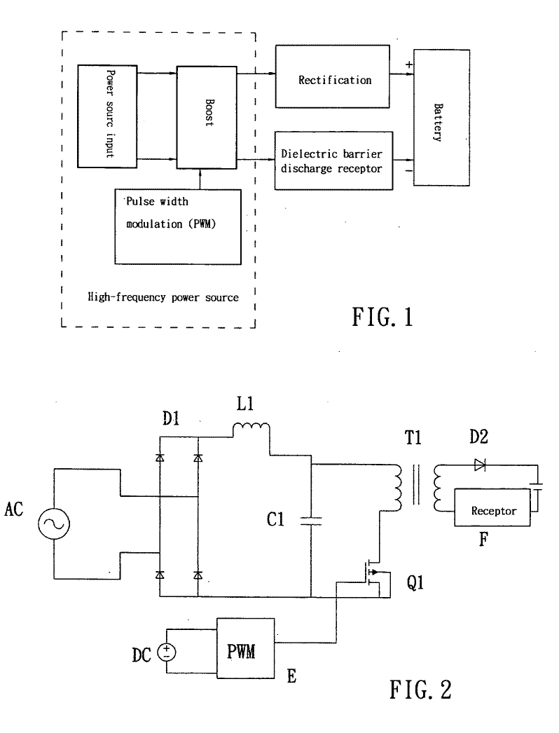

With reference to FIGS. 1 and 2 for a method for reducing a lead sulfate compound used in a lead-acid battery in accordance with the present invention, a positive half-cycle pulse high-frequency power source is inputted to an anode of the battery to charge the battery, while a cathode of the battery is connected to a dielectric barrier discharge receptor, for producing and providing high-frequency multi-band harmonic waves and a plurality of plasma into a battery to achieve the effects of reducing a lead sulfate compound, promoting a normal electrochemical reaction of the battery, and extending the life of the battery.

A method for reducing a lead sulfate compound used in a lead-acid battery in accordance with the present invention comprises the steps of:

applying a high-frequency power source to a rectifier diode, for producing a high-frequency voltage with a positive half-cycle pulse to charge a lead-acid battery;

applying a high-frequency power source to a dielectric barrier discharge receptor, for producing and inputting high-frequency multi-band harmonic waves and plasma into a battery to reduce a sulfurated acid-lead compound; and

repeating the aforementioned steps, such that an electrochemical reaction of the lead-acid battery can be conducted normally to enhance the life of the lead-acid battery.

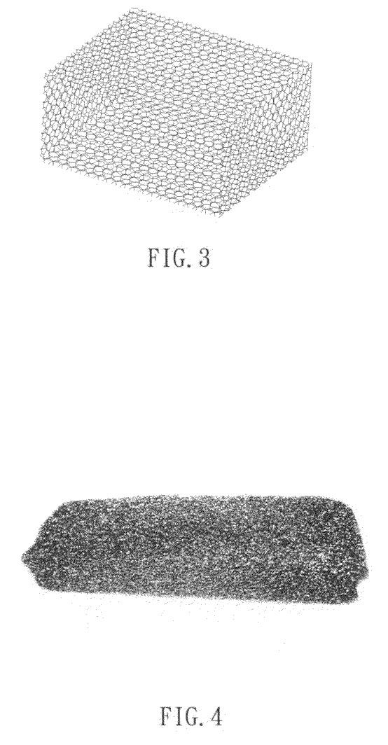

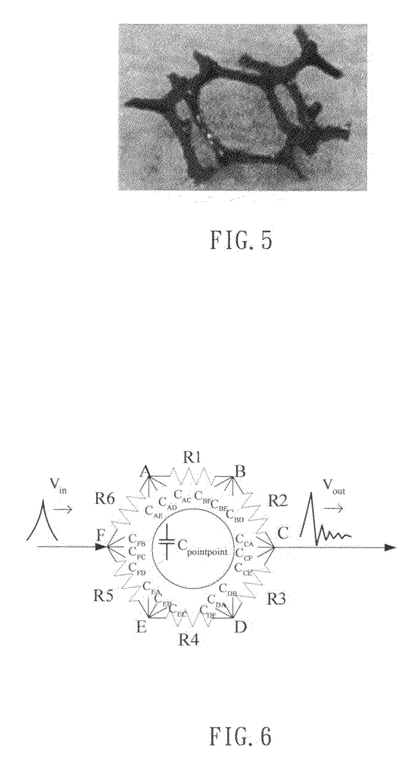

With reference to FIGS. 3 to 5 for a dielectric barrier discharge (DBD) receptor which is a porous conductive dielectric receptor, the DBD receptor has the following characteristics:
(1) The conductive dielectric receptor can be made of a conducting carbon material or a conducting metal material.
(2) The porous conductive dielectric receptor can be a regular mesh structure, an irregular mesh structure or a sponge-shaped structure with a plurality of irregular air gaps therein as shown in FIGS. 3 and 4.
(3) The receptor has a plurality of nonlinear time-varying resistors and nonlinear time-varying capacitor as shown in FIG. 6.
(4) The receptor has a voltage waveform of a corona discharge having a high-frequency pulse with a sharp rising edge.
(5) A plurality of receptors with different equivalent resistance and equivalent capacitance can be produced.
(6) A plurality of receptors with different receptors with different high-frequency multi-band harmonic waves can be produced.
(7) A plurality of non-thermal equilibrium plasma can be produced.

The frequency provided by the high-frequency power source of the present invention falls within a range of 6 kHz˜200 kHz and the dominant frequency falls within a range of 6 kHz˜12 kHz and preferably at 10 kHz for supplying a voltage ranging from 300V to 600V and preferably 500V. The pulse supplied by the pulse high-frequency power source is a positive half-cycle pulse.

The present invention uses a conductive dielectric receptor with special shape and structure as a dielectric barrier discharge receptor for charging the battery as well as the following effects:

1. The characteristics of the sponge structure give rise to different equivalent resistance and equivalent capacitance effects, and when these nonlinear time-varying resistors and time-varying capacitors provides a high-frequency power source of a constant frequency, the interaction of these different equivalent resistors and equivalent capacitors will generate a voltage of higher frequency and more bands. Since the structure of the nonlinear time-varying resistors and time-varying capacitors is non-uniform, the current will be passed through the shortest path on the surface of a conductor, if the structure is a good conductor. However, the nonlinear time-varying resistors and time-varying capacitors come with a non-uniform sponge structure, and the current will flow into the sponge structure, causing a non-uniform current and a different inductance, and such inductance varies with time. In the meantime, the invention also has a capacitance effect, such that when a high-frequency power source with a constant frequency is supplied, the nonlinear time-varying resistor and time-varying capacitor produce high-frequency multi-band harmonic waves as shown in FIG. 6. Due to the high-frequency multi-band harmonic waves, the electrodes in a battery can have different depths, size and random Eddy current effect for decomposing the sulfurated lead sulfate crystals into tiny powdered crystals to achieve the final activation effect.

2. Due to the conductive dielectric receptor with special sponge shape and structure having irregular air gaps for passing airflow, and the characteristic of a voltage waveform of a corona discharge of a high-frequency pulse with a sharp rising edge as shown in FIGS. 3 to 5, when high-frequency power source with a constant frequency is applied to the dielectric barrier discharge receptor, the discharge process of the internal air produces a large quantity of electronics, such that a non-thermal equilibrium plasma or a low-temperature plasma is produced at normal temperature and pressure, and the technology is characterized in that the technology adopts a power source with a narrow range of pulse voltage (300V˜600V), a pulse voltage with a sharp rising edge, a rising time below nanoseconds, and a narrow pulse width below 20 microseconds, such that electrons are excited to form high-power electrons, and other ions with a larger mass come with a larger inertia, and thus the pulse cannot be accelerated within a short moment and basically remains unchanged. Therefore, a vast majority of the power provided by the discharge is provided for producing high-power electrons to achieve high power efficiency.

In researches and experiments, we found that the sponge-shaped dielectric barrier discharge receptor made of a conducting carbon material can be covered onto a pair of electrodes or at least one electrode and installed between the electrodes, such that when a voltage with sufficiently high pulse is applied between the two electrodes, the dielectric at the gap between the electrodes will be penetrated to produce a discharge, which is a uniform, scattered and stable discharge, and looks like a glow discharge at a low voltage. Actually, a large quantity of tiny and quick pulse discharge passages are formed in the air gaps of the irregular sponge structure, and the dielectric barrier discharge of the high-voltage high-frequency pulse can be used for producing a plurality of plasma, and the plasma and the water molecules in the battery liquid will produce an active group such as an oxygen (O) group and a hydroxide (OH) group with strong oxidation capability.

The method of the present invention adopts the technology of producing plasma by a dielectric barrier discharge receptor with a high-voltage high-frequency pulse and reduces the lead sulfate compound of the lead-acid battery includes the following two ways:

(1) High-power particles in the non-thermal equilibrium plasma directly break the molecular bond of air in the lead-acid battery to form monoatomic molecules and tiny solid particles. (2) The water molecules in the battery liquid are ionized and excited to form ions, excited molecules and sub-electrons within 10 seconds to produce active free radical groups such as OH, O and H groups with a strong reactivity, wherein OH is the strongest one among all common oxidizers, and reacted easily with the lead sulfate compound SO₂ in an acid battery to form sulfuric acid H₂SO₄. These active groups conduct a series of chemical reactions with PbSO₄ to reduce the lead sulfate into H₂SO₄, and the process is shown as follows:

e⁻+O₂(in the air or in a battery)→e⁻+2O₂⁺

e⁻+H₂O(in the air or in a battery)→e−+OH⁻+H⁺

SO₂(in a battery)+O→SO₃

SO₂(in a battery)+OH−→HSO₃

SO₃+H₂O(in a battery)→H₂SO₄

HSO₃+OH⁻→H₂SO₄

The basic principle of the method used by the present invention is the same as that for the electron bean irradiation method and pulse chorona plasma method, and only the discharge method and reaction container (medium or material) are different. Therefore, high-energy electrons and oxygen molecules in the air are collided with the water molecule in the battery liquid to decompose, ionize and form the non-thermal equilibrium plasma, wherein a large quantity of active particles (such as OH⁻ and H⁺) are produced to react with a lead sulfate compound of the lead-acid battery for a normal chemical reaction including oxidation and reduction.

From the method of the present invention, it is known that a conductive dielectric receptor with special shape and structure is used as a dielectric barrier discharge receptor capable of reducing molecules including lead sulfate compound SO₂ into H₂SO₄.

In the aforementioned method of the present invention, the apparatus for reducing a lead sulfate compound used in a lead-acid battery as shown in FIGS. 1 and 2 comprises:

a high-frequency power source generator, for generating a high-frequency power source with a constant frequency, and comprising: an input circuit for supplying a power source, and having an AC power, a bridge rectifier, a filter capacitor and a filter inductor; a boost circuit, for generating high-voltage power source, and having a high-frequency transformer and a thyristor; and a PWM circuit for modulating a pulse width;

a rectifier diode, coupled between the high-frequency power source generator and the lead-acid battery, for producing a high-frequency power source with a positive pulse to charge the battery; and

a dielectric barrier discharge receptor, coupled between the high-frequency power source generator and the lead-acid battery, for producing and providing a plurality of plasma and high-frequency multi-band harmonic waves to charge the battery to achieve the effects of reducing a lead sulfate compound, promoting a normal electrochemical reaction of the battery and extending the life of the battery; characterized in that the dielectric barrier discharge receptor is a porous conductive dielectric receptor.

With reference to FIG. 2 for an apparatus in accordance with the present invention, the main operating principle of the apparatus is to pass a general alternate current AC of 110V through a bridge rectifier D1 over 300V to become a direct current (AC to DC) power, and then rectify the current through a filter inductor L1 over 100 uH and a high-voltage filter capacitor C1 over 150 uF. A thyristor Q1 is used for performing a high-frequency switch to boost the high-frequency switched power by a high-frequency transformer. After the boosted high-frequency output power is rectified by a rectifier diode D2 to form a positive half-cycle high-frequency current source, a positive output terminal inputs the current to an anode plate of the lead-acid battery and a dielectric barrier discharge receptor connected to a negative output terminal, such that the circuit produces super high-frequency multi-band harmonic waves and a plurality of plasma inputted from the negative output terminal to a cathode plate of the lead-acid battery, wherein the thyristor Q1 is controlled by a modulation circuit composed of a PWM IC, and the frequency of the PWM IC falls within a range of 6 kHz˜200 kHz, and the dominant frequency is equal to 10 kHz, so that when the apparatus of the invention is used, high frequency, multiband and plasma can be produced.

In summation of the description above, a method and an apparatus for reducing a lead sulfate compound used in a lead-acid battery in accordance with the present invention mainly uses a conductive dielectric receptor with special shape and structure as a dielectric barrier discharge receptor to produce high-frequency multi-band harmonic waves and a plurality of non-thermal equilibrium plasma to reduce a lead sulfate compound for promoting the normal electrochemical reactions including the oxidation and reduction of the battery, so as to achieve the expected effects of extending the life of the battery, complying with the market requirements, avoiding unnecessary wastes of energy, and reducing environmental pollutions.

While we have shown and described the embodiment in accordance with the present invention, it should be clear to those skilled in the art that further embodiments may be made without departing from the scope of the present invention.

What is claimed is:

1. A method for reducing a lead sulfate compound used in a lead-acid battery, comprising the steps of:
applying a high-frequency power source to a rectifier diode, for generating a high-frequency pulse power source to charge the battery;
applying a high-frequency power source to a dielectric barrier discharge receptor, for generating and supplying a plasma and a high-frequency multi-band power source into the battery to reduce a lead sulfate compound; and
repeating the foregoing steps to promote a normal electrochemical reaction of the lead-acid battery.

2. The method for reducing a lead sulfate compound used in a lead-acid battery as recited in claim 1, wherein the high-frequency multi-band power source generated by the dielectric barrier discharge receptor provides at least one different high-frequency harmonic wave.

3. The method for reducing a lead sulfate compound used in a lead-acid battery as recited in claim 1, wherein the high-frequency multi-band power source generated by the dielectric barrier discharge receptor supplies a frequency from 6 kHz to 200 kHz.

4. The method for reducing a lead sulfate compound used in a lead-acid battery as recited in claim 1, wherein the high-frequency multi-band power source generated by the dielectric barrier discharge receptor supplies a main frequency from 6 kHz to 12 kHz.

5. The method for reducing a lead sulfate compound used in a lead-acid battery as recited in claim 1, wherein the high-frequency multi-band power source supplies a voltage from 300V to 600V.

6. The method for reducing a lead sulfate compound used in a lead-acid battery as recited in claim 1, wherein the high-frequency multi-band power source provides a waveform which is a high-voltage pulse waveform with a sharp rising edge.

7. The method for reducing a lead sulfate compound used in a lead-acid battery as recited in claim 1, wherein the dielectric barrier discharge receptor is a conductive dielectric receptor having a nonlinear time-varying resistor and a nonlinear time-varying capacitor.

8. The method for reducing a lead sulfate compound used in a lead-acid battery as recited in claim 1, wherein the high-frequency pulse power source provides a positive half-cycle pulse.

9. The method for reducing a lead sulfate compound used in a lead-acid battery as recited in claim 1, wherein the plasma is a non-thermal equilibrium plasma.

10. An apparatus for reducing a lead sulfate compound used in a lead-acid battery, comprising:
a high-frequency power source generator, for generating a high-frequency power source;
a rectifier diode, coupled between the high-frequency power source generator and the lead-acid battery, for generating and supplying a high-frequency pulse power source to charge the battery; and
a dielectric barrier discharge receptor, coupled between the high-frequency power source generator and the lead-acid battery, for generating and supplying a plasma and a high-frequency multi-band harmonic wave to the battery to reduce the lead sulfate compound;
characterized in that: the dielectric barrier discharge receptor is a porous conductive dielectric receptor.

11. The apparatus for reducing a lead sulfate compound used in a lead-acid battery as recited in claim 10, wherein the porous conductive dielectric receptor is a conducting carbon material or a conducting metal material.

12. The apparatus for reducing a lead sulfate compound used in a lead-acid battery as recited in claim 10, wherein the porous conductive dielectric receptor is a regular mesh structure or an irregular mesh structure.

13. The apparatus for reducing a lead sulfate compound used in a lead-acid battery as recited in claim 10, wherein the porous conductive dielectric receptor is a sponge shaped structure having a plurality of irregular air gaps therein.

14. The apparatus for reducing a lead sulfate compound used in a lead-acid battery as recited in claim 10, wherein the high-frequency power source generator comprises:
an input circuit, for supplying a power source including an AC power, a bridge rectifier, a filter capacitor and a filter inductor;
a boost circuit, for generating a high-voltage power source including a transformer and a thyristor; and
a pulse width modulation (PWM) circuit for modulating a pulse width.
